(19) United States
(12) Patent Application Publication
(10) Pub. No.: US 2007/0100484 A1
(43) Pub. Date: May 3, 2007

(54) Television system with saving function of output power

(75) Inventor: Ki-soo Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/583,865

(22) Filed: Oct. 20, 2006

(30) Foreign Application Priority Data
Oct. 20, 2005 (KR) 10-2005-0099205

(51) Int. Cl. G06F 17/00

(52) U.S. Cl. 700/94

(57) ABSTRACT

A digital television system capable of controlling the supply of output power is provided. The digital television system includes a sound signal supply unit which processes digital signals received from an external source and generates digital audio signals; a sound signal processor which receives and converts the generated digital audio signals to analog audio signals and outputs the analog audio signals; a power supply unit which supplies electric power to the sound signal processor; a digital output terminal outputs the digital audio signals from the sound signal supply unit; and a controller which controls the power supply unit to terminate a supply of electric power to the sound signal processor if the digital output terminal is connected to an external device.

### CROSS-REFERENCE TO RELATED APPLICATIONS

This application claims priority from Korean Patent Application No. 10-2005-0099205, filed on Oct. 20, 2005, in the Korean Intellectual Property Office, the disclosure of which is incorporated herein by reference.

### BACKGROUND OF THE INVENTION

1. Field of Invention

Methods and apparatuses consistent with the present invention relate to a television system, more specifically, to a television system capable of controlling supply of output power for the television system according to a connection state of an output terminal.

2. Description of the Related Art

A digital television is an apparatus which receives audio and video signals (A/V signals) in the form of digital signals and outputs images and sounds. Generally, a digital television has an advantage that the properties of its reproduced images and sounds are excellent compared with related art signal processing apparatuses which output analog signals. Accordingly, recent broadcast signals are generated as digital signals as well as conventional analog signals.

Many currently manufactured digital televisions have an additional function of receiving analog signals in order to cope with analog broadcast signals in addition to digital broadcast signals. Additionally, the digital television comprises a digital audio output terminal for the output of digital audio signals in addition to a sound signal processor for the output of analog sounds.

Therefore, a user can hear sounds which are reproduced not only in an analog mode through the sound signal processor provided in the digital television, but also reproduced through an external device connected to the digital audio output terminal to receive a digital sound source.

However, according to the related art digital television, even in the case that the audio signals are output to the external device through the digital audio output terminal, the output power is still supplied to the sound signal processor, which leads to an unnecessary consumption of electric power.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a television system capable of preventing the unnecessary consumption of electric power during the output of audio signals.

According to an aspect of the present invention, there is provided a digital television system comprising: a sound signal supply unit which processes digital signals received from an external source to generate digital audio signals; a sound signal processor which receives and converts the digital audio signals generated by the sound signal supply unit to analog audio signals and outputs the analog audio signals; a power supply unit which supplies electric power to the sound signal processor; a digital output terminal which outputs the digital audio signals from the sound signal supply unit; and a controller which controls the power supply unit to terminate a supply of electric power to the sound signal processor if the digital output terminal is connected to an external device.

According to an aspect of the present invention, the sound signal processor comprises a sound processor which receives and converts the digital audio signals to the analog audio signals, and an amplifying unit which amplifies the analog audio signals, and the controller controls the power supply unit to terminate the supply of electric power to at least one of the sound processor and the amplifying unit.

According to an aspect of the present invention, the amplifying unit comprises a signal processor which converts and optimizes the analog audio signals, and an amplifier which amplifies the optimized analog audio signals to have an appropriate strength for output, and the controller controls the power supply unit to terminate the supply of electric power to at least one of the sound processor, the signal processor, and the amplifier.

According to an aspect of the present invention, the sound processor further comprises an analog output terminal which outputs the analog audio signals, and the controller controls the power supply unit to terminate the supply of electric power to the amplifying unit if the analog output terminal is connected to an external device.

According to an aspect of the present invention, the amplifying unit comprises a signal processor which converts and optimizes the analog audio signals, and an amplifier which amplifies the optimized analog audio signals to have an appropriate strength for output, and the controller controls the power supply unit to terminate the supply of electric power to at least one of the signal processor and the amplifier.

According to another aspect of the present invention, there is provided a television system comprising: a sound processor which processes and outputs analog audio signals received from the outside; an amplifying unit which amplifies the processed analog audio signals; a power supply unit which supplies electric power to the sound processor and the amplifying unit; an analog output terminal connected to which outputs the analog audio signals processed by the sound processor; and a controller which controls the power supply unit to terminate a supply of electric power to the amplifying unit if the analog output terminal is connected to an external device.

According to an aspect of the present invention, the amplifying unit comprises a signal processor which converts and optimizes the analog audio signals, and an amplifier which amplifies the optimized analog audio signals to have an appropriate strength for output, and the controller controls the power supply unit to terminate the supply of electric power to at least one of the signal processor and the amplifier.

### BRIEF DESCRIPTION OF THE DRAWINGS

The above and/or other aspects of the prevent invention will become apparent and more readily appreciated from the following description of the exemplary embodiments, taken in conjunction with the accompany drawings, in which:

FIG. 1 is a block diagram partly showing a constitution of a digital television system according to an exemplary embodiment of the present invention; and

FIG. 2 is a block diagram showing in detail a portion of FIG. 1.

### DETAILED DESCRIPTION OF EXEMPLARY EMBODIMENTS OF THE INVENTION

Reference will now be made in detail to the exemplary embodiments of the present invention, examples of which are illustrated in the accompanying drawings, wherein like reference numerals refer to like elements throughout. The exemplary embodiments are described below so as to explain the present invention by referring to the figures.

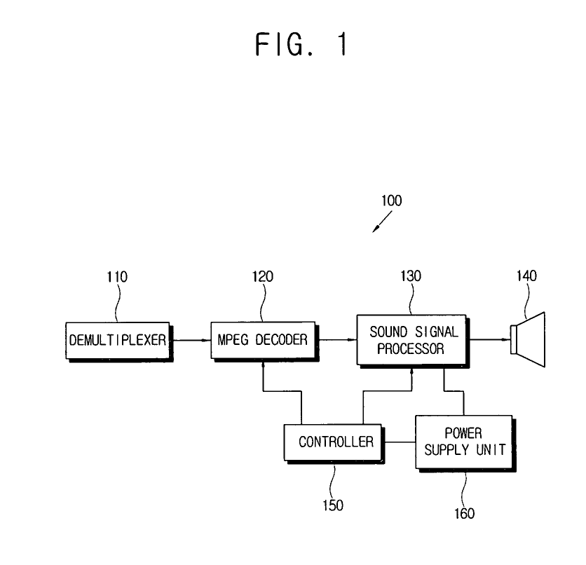

A digital television system 100 according to an exemplary embodiment of the present invention, as shown in FIG. 1, comprises a demultiplexer 110, an Moving Pictures Expert Group (MPEG) decoder 120, a sound signal processor 130, a speaker 140, and a controller 150. Also, the digital television system 100 further comprises a power supply unit 160 that provides electric power to the above elements. As described below, the controller 150 controls a supply of electric power of the power supply unit 160.

The demultiplexer 110 separates audio and video (A/V) signals from digital signals which have been received through a tuner provided in the digital television system 100. The A/V signals separated by the demultiplexer 110 are divided into digital audio signals and digital video signals by the MPEG decoder 120. The digital video signals are transmitted to an image signal processor (not shown) to be processed, and finally are displayed through a display unit (not shown).

The digital audio signals obtained through the separation operation by the MPEG decoder 120 are processed through the sound signal processor 130, and then converted to analog signals and amplified, to thereby be output through the speaker 140.

As described above, it can be seen that, in view of audio signals, the MPEG decoder 120 functions as a sound signal supply unit which generates digital audio signals.

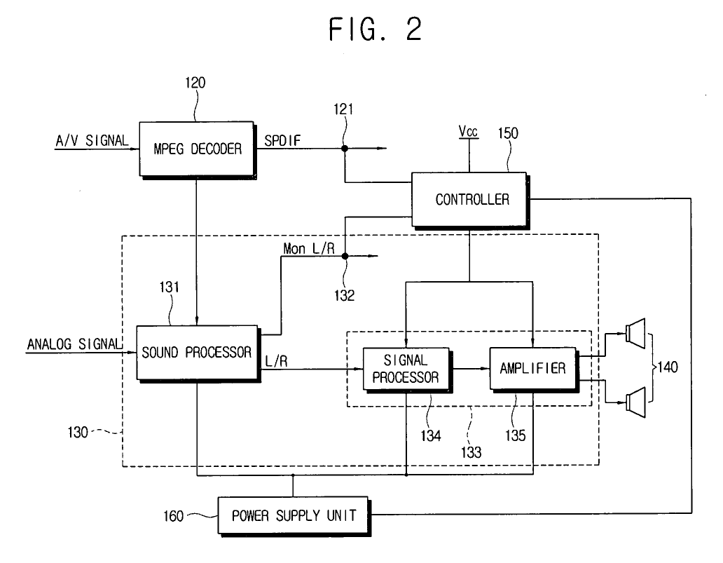

The controller 150 detects and controls the sound signal processor 130 and the MPEG decoder 120, and controls the output power of the sound signal processor 130 as described below. FIG. 2 is a block diagram partly showing in more detail the digital television system 100 of FIG. 1.

The MPEG decoder 120 receives the A/V signals and generates digital audio signals from the received A/V signals, and transmits the generated digital audio signals to a sound processor 131 that is an element of the sound signal processor 130. Additionally, the MPEG decoder 120 further comprises a digital output terminal 121 through which the generated digital audio signals can be transmitted to an external device. Through the digital output terminal 121, signals of Sony Phillips Digital Interface (SPDIF) mode may be output to maintain compatibility with the external device. The external device may be a digital audio, a digital TV, a computer, or the like.

The sound signal processor 130 comprises the sound processor 131 and an amplifying unit 133 which includes a signal processor 134 and an amplifier 135, as shown in FIG. 2.

The sound processor 131 receives the digital audio signals from the MPEG decoder 120 and converts the digital audio signals into analog audio signals. Also, the sound signal processor 130 receives audio signals which are input as analog signals directly from an outside source, and performs a predetermined process. Therefore, it can be seen that the digital audio signals are processed by the sound processor 131 through the MPEG decoder 120, and the analog audio signals are directly processed by the sound processor 131.

The sound processor 131 comprises an analog output terminal 132 which may enable transmission of the analog audio signals directly to an external device. The analog output terminal 132 is connected to the external device, which is provided with an analog input terminal, such as an audio, a television, or the like.

The analog audio signals converted or processed by the sound processor 131 may be processed by the amplifying unit 133. That is, the analog audio signals may be converted into optimized analog signals through Pulse Width Modulation (PWM) processing by the signal processor 134 of the amplifying unit 133, and may be amplified to have an appropriate strength for output by the amplifier 135 and transmitted to the speaker 140.

The controller 150 is electrically connected to the digital output terminal 121 of the MPEG decoder 120 and the analog output terminal 132 of the sound processor 131. Through the connections, the controller 150 may determine whether external devices are connected to the terminals 121 and 132.

Also, the controller 150 controls a supply of electric power by the power supply unit 160 to the sound processor 131 and the amplifying unit 133.

That is, in the case that the digital output terminal 121 is connected to an external device and thus an audio output is accomplished through the external device, the controller 150 controls the power supply unit 160 to terminate a supply of power to the sound processor 131 and the amplifying unit 133, that is, the signal processor 134 and the amplifier 135. Therefore, unnecessary power consumption at the sound processor 131 and the amplifying unit 133 may be prevented.

Although the controller 150 may terminate all electric power supplied to the sound processor 131 and the amplifying unit 133, a supply of electric power to at least one of the sound processor 131, the signal processor 134 and the amplifier 135 may be terminated according to another exemplary embodiment of the present invention.

In the case that the analog output terminal 132 connected to the sound processor 131 is connected to an external device and thus an audio output is accomplished through the external device, the controller 150 controls the power supply unit 160 to terminate a supply of electric power to the amplifying unit 133. In this case as well, as described above, although the controller 150 may terminate all electric power supplied to the signal processor 134 and the amplifier 135 which constitute the amplifying unit 133, the supply of power to one of the signal processor 134 and the amplifier 135 may be terminated according to another exemplary embodiment of the present invention.

Although the control of the output power has been described only for the digital television system 100 in the foregoing exemplary embodiment of the present invention, the exemplary embodiments of the present invention are not limited to the digital television system but are also applicable to an analog television system.

That is, if digital elements, including the MPEG decoder 120, are excluded from the digital television system 100 of FIG. 2, the television system of the analog mode including the sound processor 131 which receives the analog signals, and the amplifying unit 133 which amplifies analog audio signals processed by the sound processor 131 may be utilized.

With such a television system of analog mode, in the case that the analog output terminal 132 connected to the sound processor 131 is connected to an external device, the controller 150 may detect the connection of the external device and terminate a supply of electric power to the amplifying unit 133 to prevent unnecessary consumption of electric power.

As described above, according to the television system of the exemplary embodiments of the present invention, unnecessary consumption of electric power in the television system may be prevented by terminating the output power when an external device connected to the digital output terminal or the analog output terminal is detected.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A digital television system comprising:
a sound signal supply unit which processes digital signals received from an external source and generates digital audio signals;
a sound signal processor which receives and converts the digital audio signals generated by the sound signal supply unit to analog audio signals and outputs the analog audio signals;
a power supply unit which supplies electric power to the sound signal processor;
a digital output terminal which outputs the digital audio signals from the sound signal supply unit; and
a controller which controls the power supply unit to terminate a supply of electric power to the sound signal processor if the digital output terminal is connected to an external device.

2. The digital television system according to claim 1, wherein the sound signal processor comprises a sound processor which receives and converts the digital audio signals to the analog audio signals, and an amplifying unit which amplifies the analog audio signals, and
the controller controls the power supply unit to terminate a supply of electric power to at least one of the sound processor and the amplifying unit if the digital output terminal is connected to the external device.

3. The digital television system according to claim 2, wherein the amplifying unit comprises a signal processor which converts and optimizes the analog audio signals, and an amplifier which amplifies the optimized analog audio signals to have an appropriate strength for output, and
the controller controls the power supply unit to terminate the supply of electric power to at least one of the sound processor, the signal processor, and the amplifier if the digital output terminal is connected to the external device.

4. The digital television system according to claim 2, wherein the sound processor further comprises an analog output terminal which outputs the analog audio signals, and
the controller controls the power supply unit to terminate the supply of electric power to the amplifying unit if the analog output terminal is connected to an external device.

5. The digital television system according to claim 4, wherein the amplifying unit comprises a signal processor which converts and optimizes the analog audio signals, and an amplifier which amplifies the optimized analog audio signals to have an appropriate strength for output, and
the controller controls the power supply unit to terminate a supply of electric power to at least one of the signal processor and the amplifier if the analog output terminal is connected to the external device.

6. The digital television system according to claim 1, wherein the sound signal supply unit comprises an MPEG decoder.

7. A television system comprising:
a sound processor which processes and outputs analog audio signals received from an external source;
an amplifying unit which amplifies the analog audio signals processed by the sound processor;
a power supply unit which supplies electric power to the sound processor and the amplifying unit;
an analog output terminal which outputs the analog audio signals processed by the sound processor; and
a controller which controls the power supply unit to terminate a supply of electric power to the amplifying unit if the analog output terminal is connected to an external device.

8. The television system according to claim 7, wherein the amplifying unit comprises a signal processor which converts and optimizes the analog audio signals, and an amplifier which amplifies the optimized analog audio signals to have an appropriate strength for output, and
the controller controls the power supply unit to terminate the supply of electric power to at least one of the signal processor and the amplifier if the analog output terminal is connected to an external device.
